(19) United States
(12) Patent Application Publication
(10) Pub. No.: US 2022/0189239 A1
(43) Pub. Date: Jun. 16, 2022

(54) GAME DEVICE, GAME CONTROL METHOD, AND RECORDING MEDIUM

(71) Applicant: SEGA SAMMY CREATION INC., Kanagawa (JP)

(72) Inventors: Masaaki Kojima, Osaka (JP); Masaya Ominami, Osaka (JP)

(73) Assignee: SEGA SAMMY CREATION INC., Kanagawa (JP)

(21) Appl. No.: 16/606,900

(22) PCT Filed: May 20, 2019
(86) PCT No.: PCT/JP2019/019925

§ 371 Date: Feb. 1, 2022

(51) Int. Cl. G07F 17/32; G07F 17/34

(52) U.S. Cl. CPC G07F 17/3213; G07F 17/34

(57) ABSTRACT

A game device includes a control section, a storage section, and a display section. The control section performs a game control method by executing a program stored in the storage section. The game control method includes displaying an image of spin of a reel in a first display area of the display section, and updating, in the case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

### TECHNICAL FIELD

The present invention relates to a game device, a game control method, and a recording medium.

### BACKGROUND ART

Various game devices are developed. Patent Document 1 discloses a reel game (slot game) which allows a bonus game to be played in combination with a normal game to increase the interest of the game. In the bonus game, the probability that a privilege is obtained according to the result of play is greater than that in the normal game.

### PRIOR ART

### Patent Document

Patent Document 1: U.S. Pat. No. 7,520,809

### SUMMARY

### Technical Problem

It is desired to implement a reel game having interest higher than that of a conventional reel game.

The present invention has been made in view of the foregoing, and an object thereof is to provide a technique for implementing a reel game having higher interest.

### Solution to Problem

A game device in an aspect of the present invention is a game device including: a control section; a storage section; and a display section, wherein the control section is configured to execute a program stored in the storage section to display an image of spin of a reel in a first display area of the display section, and update, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

A game control method in an aspect of the present invention is a method which is performed in a game device including a control section and a storage section, the method which includes: causing the control section to display an image of spin of a reel in a first display area of the display section; and causing the control section to update, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

A recording medium in an aspect of the present invention is a recording medium which stores a program for causing a game device including a control section, a storage section, and a display section to execute a game control method, the game control method including: causing the control section to display an image of spin of a reel in a first display area of the display section; and causing the control section to update, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

### Advantageous Effects of Invention

According to the present invention, it is possible to provide the technique for implementing the reel game having higher interest.

### BRIEF DESCRIPTION OF DRAWINGS

FIG. 1 is an external perspective view of a game device in an embodiment.

FIG. 2 is a block diagram showing main hardware components of the game device in an embodiment.

FIG. 3 is a conceptual view showing an example of a screen displayed in a display device in an embodiment.

FIG. 4 is a conceptual view showing an example of the screen displayed in the display device in an embodiment.

FIG. 5 is a conceptual view showing an example of the screen displayed in the display device in an embodiment.

FIG. 6 is a conceptual view showing an example of the screen displayed in the display device in an embodiment.

FIG. 7 is a conceptual view showing an example of the screen displayed in the display device in an embodiment.

FIG. 8 is a conceptual view showing an example of the screen displayed in the display device in an embodiment.

FIG. 9 is a flowchart for explaining a process by the game device in an embodiment.

### DESCRIPTION OF EMBODIMENTS

Hereinbelow, a description will be given of embodiments of the present invention with reference to the drawings. Note that the embodiments described below are only exemplary, and it is not intended to exclude application of various modifications and techniques which are not described explicitly below. That is, the present invention may be implemented by variously modifying the individual embodiments or combining the individual embodiments without departing from the gist thereof. In addition, in the following description of the drawings, the same or similar portions are designated by the same or similar reference numerals. The drawings are schematic, and do not necessarily match the actual dimensions or ratios. There are cases where portions with mutually different dimensional relationships or ratios are included in the drawings.

[Examples of Hardware Components of Game Device]

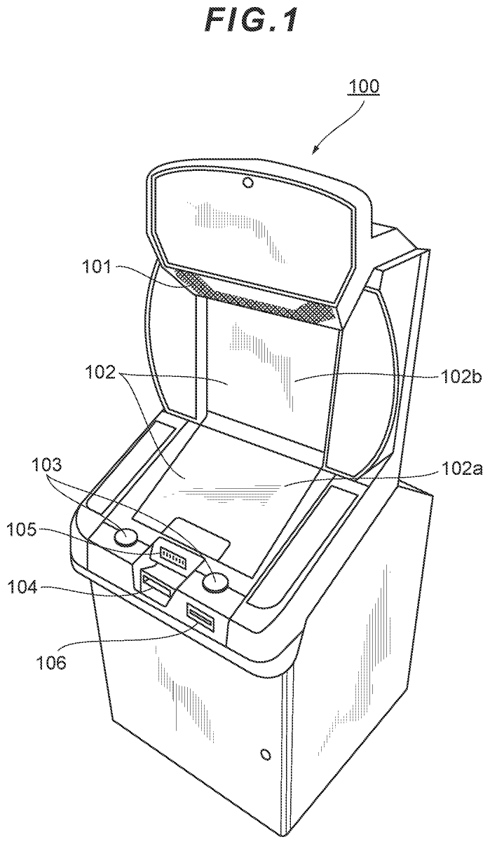

FIG. 1 is an external perspective view of a game device in an embodiment. A game device 100 shown as an example in FIG. 1 is a game device which is installed in a casino or an amusement facility. In the present embodiment, a player can play a reel game (slot game) with the game device 100.

As shown in FIG. 1, the game device 100 externally includes a speaker 101, a plurality of display devices 102, a plurality of operation buttons (hereinafter referred to as an “operation input device” 103), a card reading device 104, a bill insertion device 105, and a ticket delivery device 106. The speaker 101 is sound output means for outputting voice guidance and sound effects of a game. The display devices 102 include a main panel 102a and a sub-panel 102b. Each display device 102 is display means for displaying an image (e.g., a still image, a moving image, a picture, or the like) for expressing or directing the game. The operation input device 103 is constituted by a plurality of buttons which are used to input instructions from the player to the game device. In addition, in the present embodiment, a touch panel serving as the operation input device 103 is provided integrally with the display device 102, and the touch panel can receive an operation instruction corresponding to the coordinates of a position on a display section of the display device 102 which is touched by the player. Note that the operation input device 103 is not limited to the above configuration, and the operation input device 103 may have any configuration to which the player can input the instruction. The card reading device 104 is a card reader which reads information from a card of the player. The bill insertion device 105 is a device which reads an inserted bill or ticket. The ticket delivery device 106 is ticket output means for delivering the card to the player.

The card which is read by the card reading device 104 is a medium, which stores play information of the player. For example, it is possible to add points obtained according to the play situation of the player to the card, or store information on consumption in the card. Although the player can receive various services according to the information stored in the card, the stored content of the card does not influence the result of play.

In addition, the game device 100 includes a computing device serving as a control device which collectively controls the game device 100 inside the game device 100.

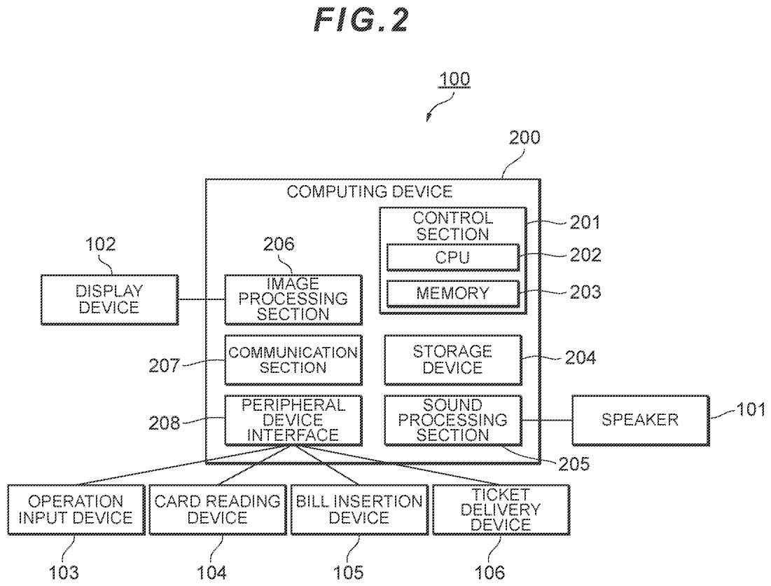

A description will be given of examples of hardware components of a computing device 200 provided inside the game device 100 with reference to FIG. 2. As shown in FIG. 2, as its main hardware components, the computing device 200 includes a control section 201, a storage device 204, a sound processing section 205, an image processing section 206, a communication section 207, and a peripheral device interface 208.

The control section 201 includes a CPU (Central Processing Unit) 202 and a memory 203. For example, the CPU 202 executes predetermined computer programs (e.g., programs of game software) stored in the memory 203 and the storage device 204, and the computing device 200 thereby controls the processes and operations of other hardware components to implement various functions. That is, the computing device 200 cooperates with other hardware to implement game functions by executing the predetermined computer programs under the control of the control section 201. Note that FIG. 2 shows only the principal components of the computing device 200, and the computing device 200 includes other components provided in a typical information processing device.

The storage device 204 is constituted by a hard disk ora semiconductor storage device. In the storage device 204, read and write of data are performed by the control section 201. Data such as a computer program or the like required for processing in the computing device 200 is written in the storage device 204, and data on the processing result is further written therein. The sound processing section 205 performs various sound processing under the control of the control section 201, and outputs data on the processing result to the speaker 101. The image processing section 206 performs various graphics processing under the control of the control section 201, and outputs data on the processing result to the display device 102. The communication section 207 is an interface which allows communication with a server or other game devices. The peripheral device interface 208 is an interface which allows the computing device 200 to communicate with peripheral equipment such as the operation input device 103, the card reading device 104, the bill insertion device 105, and the ticket delivery device 106.

[Example of Content of Game]

Next, a description will be given of an example of the content of a game which the player can play with the game device 100 of the present embodiment. The game device 100 loads a computer program stored in the storage device 204 or the like into the memory 203 and executes the computer program under the control of the control section 201 to control the operations of various components of the game device 100, whereby this game is implemented.

First, in order to start the game, the player inserts the card of the player into the card reading device 104 of the game device 100, and inserts the bill or ticket into the bill insertion device 105. When the bill or ticket is inserted, the player can own credits corresponding to the inserted bill or ticket in the game. In the present embodiment, the credit is a virtual currency which can be used in the game or the like.

Next, the game device 100 generates a betting screen for the player to bet in the reel game with the control section 201 and the image processing section 206, and causes the display device 102 to display the betting screen. The game device 100 starts the reel game in response to the betting by the player and the operation instruction to start the reel game. The reel game which is allowed to be played by inserting the bill or the like and paying in the above manner is referred to as a “normal game” in the following description. In contrast to this, the reel game which can be played free of charge without paying is referred to as a “free game” in the following description.

In the normal game, first, the game device 100 causes the display device 102 to display an image in which a plurality of virtual reels (e.g., five reels. Hereinafter, the virtual reel is also simply referred to as a “reel”) spin, and stops the spin of each of the reels at random timing in the display. After the spin is stopped, part of each reel is displayed in the display device 102.

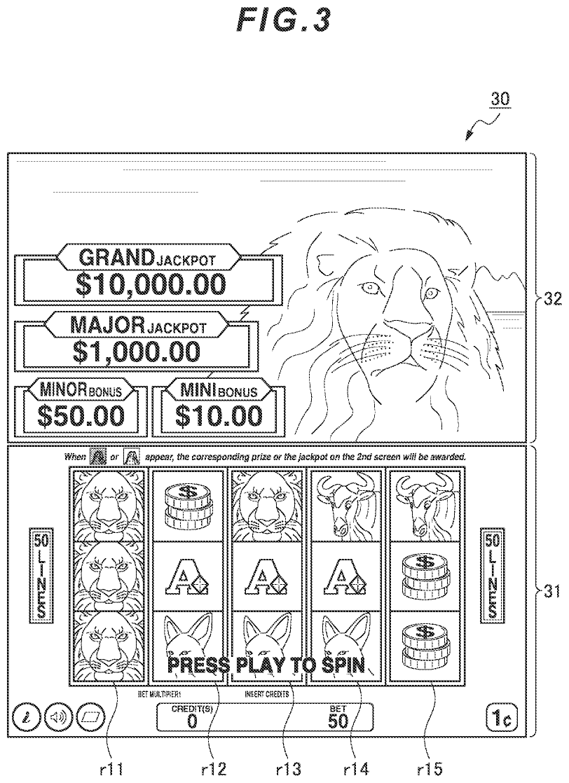

FIG. 3 shows an exemplary image 30 which is displayed in the display devices 102 when the spin of the reels is stopped in the normal game. The image 30 includes an image 31 displayed in the main panel 102a, and an image 32 displayed in the sub-panel 102b. The image 31 is an image which is mainly seen by the player during the play. The image 32 is an image which is complementarily seen by the player, and displays sums of money when JACKPOT is won.

The image 31 displays part of each of reels r11, r12, r13, r14, and r15. Each reel has a display of a plurality of symbols (pictures) on its surface, and the portion of each reel displayed in the main panel 102a shows three symbols.

In this manner, after the reel spin is stopped, the main panel 102a displays part of a plurality of symbols provided in the reel. Various privileges (or benefits) are rewarded to the player according to whether or not the arrangement of displayed symbols matches a preset (or selected) line (payline). That is, it is determined whether or not the player has won the game (win) according to the displayed symbols and, in the case where the player has won the game, a privilege corresponding to the content of the winning is awarded to the player.

The free game will be described. For example, when the placement or type of the symbols displayed in the display device 102 satisfies a predetermined condition when the spin of the reels is stopped in the normal game, the game device 100 establishes a state in which the free game can be played. For example, when the placement of the displayed symbols satisfies the predetermined condition, a right to play the free game is awarded to the player. Thereafter, the player can play the free game a predetermined number of times (e.g., five times) consecutively. Also in the free game, various privileges such as credits and the like are awarded to the player according to the arrangement of symbols after the reel spin is stopped, the placement of predetermined symbols, or whether or not a predetermined number of predetermined symbols or more are displayed.

For example, it is assumed that the state in which the free game can be played is established when a condition that three or more symbols of coins appear is satisfied. Further, it is assumed that the right to play the free game five times is awarded when a condition that three symbols of coins appear is satisfied, the right to play the free game seven times is awarded when a condition that four symbols of coins appear is satisfied, and the right to play the free game ten times is awarded when a condition that five symbols of coins appear is satisfied. In this case, symbols indicative of coins are displayed in the upper tier of the reel r12 and the middle tier and the lower tier of the reel r15 which are shown in the image 31 in FIG. 3 and are stopped in the normal game (that is, three symbols indicative of coins appear). Accordingly, the right to play the free game five times is awarded to the player, and the game transitions to the state in which the free game can be played.

After the game transitions to the state in which the free game can be played, the game device 100 starts the reel game which is the free game in response to an operation instruction issued to the game device 100 by the player.

First, in the free game, similarly to the normal game, the game device 100 causes the display device 102 to display the image in which a plurality of reels spin, and stops the spin of each of the reels at predetermined timing in the display. After the spin is stopped, part of each reel is displayed in the display device 102.

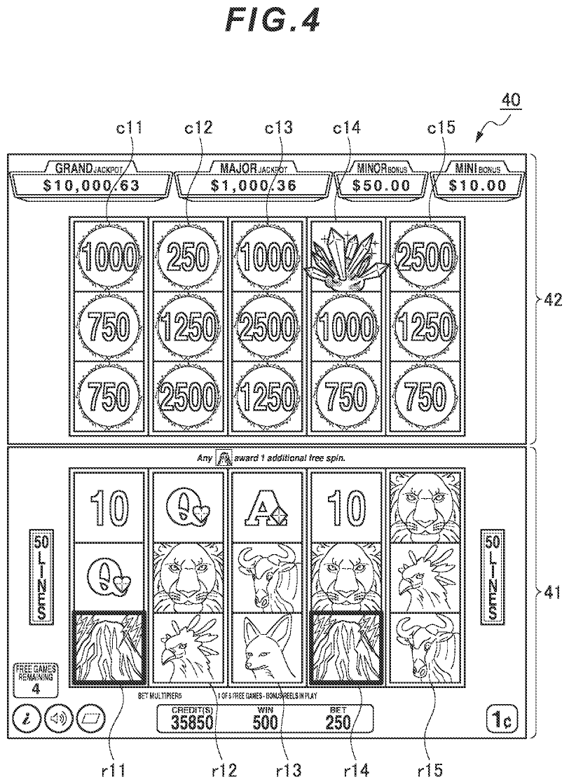

FIG. 4 shows an exemplary image 40 which is displayed in the display devices 102 when the free game is played. The image 40 includes an image 41 displayed in the main panel 102a, and an image 42 displayed in the sub-panel 102b. The image 41 is an image which is mainly seen by the player during the play, and displays reels which have ceased to spin in an example in the drawing. The image 42 is an image which is complementarily seen by the player, and shows bonus prizes in an example in the drawing. The bonus prize is a privilege which is awarded to the player as a bonus when a predetermined condition is satisfied in the free game. Information on the privilege awarded as the bonus is stored in the storage device 204 in association with identification information of the player. Hereinbelow, a description will be given of an example of a condition which allows the privilege to be awarded as the bonus.

As shown in FIG. 4, the image 41 displays the reels r11, r12, r13, r14, and r15 which have ceased to spin. Each reel has three areas in which symbols are displayed. For example, in the three areas of the reel r12, a symbol indicative of “Q”, a symbol indicative of a lion, and a symbol indicative of a bird are displayed from the top.

The image 42 displays columns c11, c12, c13, c14, and c15 which are rectangular areas. Each column has three areas in which symbols are displayed. As can be seen from FIG. 4, the shape of an area (referred to as an “area r10”) consisting of the reels r11, r12, r13, r14, and r15 is the same as or substantially similar to the shape of an area (referred to as an “area c10”) consisting of the columns c11, c12, c13, c14, and c15. In addition, ata position in the area c10 corresponding to a position at which a symbol is displayed in the area r10, a symbol is displayed.

Herein, a symbol indicative of a volcano (special symbol) is displayed in each of the lower tier of the reel r11 and the lower tier of the reel r14 in the image 41. In this manner, in the case where the special symbol is displayed in the image 41 when the spin is stopped, the bonus (privilege) corresponding to the symbol displayed at the position (second position) in the image 42 which corresponds to the position (first position) at which the special symbol is displayed in the image 41 is awarded to the player. In FIG. 4, “750” is displayed at each of the two positions in the image 42 (i.e., the lower tier of the column c11 and the lower tier of the column c14) corresponding to the lower tier of the reel r11 and the lower tier of the reel r14 in which the special symbols are displayed. In this case, 1500 (=750+750) credits are awarded to the player. Note that it is possible to use any symbol as the special symbol.

Thus, according to the present embodiment, in addition to the image displayed in the main panel 102a, the game device 100 causes the sub-panel 102b to display the image having the shape which is the same as or substantially similar to the shape of the above image during the game. When the special symbol is displayed at the first position in the main panel 102a, the privilege corresponding to the symbol displayed at the second position in the sub-panel 102b which corresponds to the first position is awarded to the player. The privilege is awarded based on the images displayed in the two panels, and hence it is possible to implement the game having higher interest.

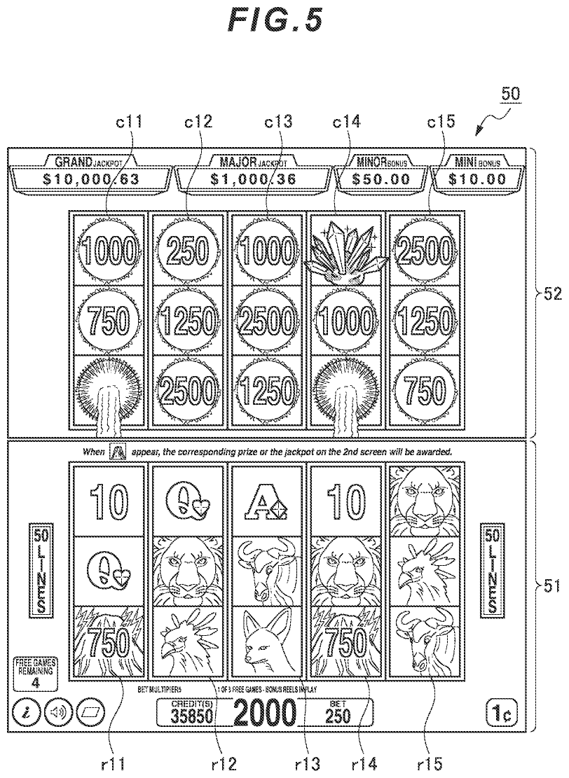

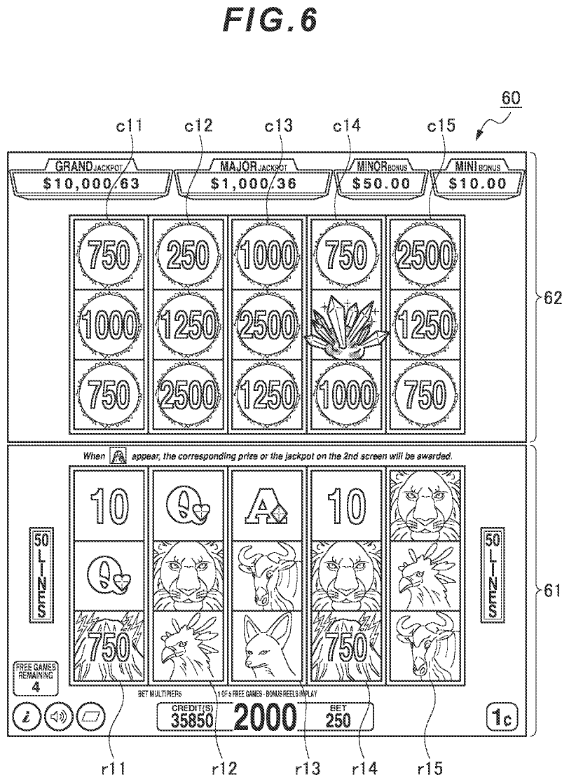

A description will be given of an example of direction which is displayed in the display devices 102 by the control of the control section 201 when the bonus is awarded with reference to FIG. 4, FIG. 5, and FIG. 6. First, as shown in FIG. 4, the special symbol indicative of a volcano described above is displayed in each of the lower tier of the reel r11 and the lower tier of the reel r14 (first position) in the image 41 displayed in the main panel 102a.

Thereafter, as shown in FIG. 5, an image (an image corresponding to the privilege) showing the credits (“750”) awarded as the privilege is displayed on each special symbol. In addition, in an image 52 displayed in the sub-panel 102b, a image in which the symbol displayed at the second position (i.e., each of the lower tier of the column c11 and the lower tier of the column c14) corresponding to the first position is blown up is displayed. By the blow-up, the privilege (the number of awarded credits) displayed on the symbol at the second position is made invisible, but the player can determine the awarded credits by looking at the display position (first position) of the special symbol in an image 51 displayed in the main panel 102a.

By the blow-up, the display of the symbol displayed at the second position is erased, and the symbol displayed in an area above the second position moves downward. That is, the display of the sub-panel 102b is updated such that the position where the symbol is erased is occupied by another symbol.

FIG. 6 shows an image 62 which is displayed in the sub-panel 102b after the movement of the symbol. The symbols having been displayed in the upper tier and the middle tier of the column c11 in FIG. 5 are displayed in the middle tier and the lower tier of the column c11 in FIG. 6. In addition, a new symbol is displayed in the upper tier of the column c11 in FIG. 6. Similarly, the symbols having been displayed in the upper tier and the middle tier of the column c14 in FIG. 5 are displayed in the middle tier and the lower tier of the column c14 in FIG. 6. In addition, a new symbol is displayed in the upper tier of the column c14 in FIG. 6.

Thus, according to the present embodiment, the spin image of the reels is displayed in the main panel 102a (first display area) of the display devices 102 (display section) by the control of the control section 201 and, thereafter, the spin of the reels is stopped. In the case where the special symbol (first symbol) is displayed in the first display area when the spin is stopped, the privilege corresponding to the symbol displayed at the second position in the sub-panel 102b (second display area) which corresponds to the first position at which the first symbol is displayed in the first display area is awarded to the player. Data stored in the storage device 204 is updated such that data on the awarded privilege is stored in association with data which identifies the player.

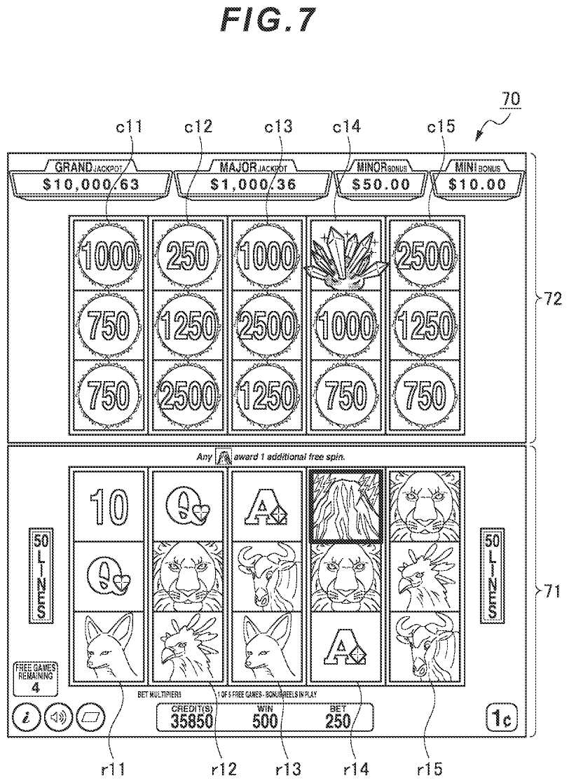

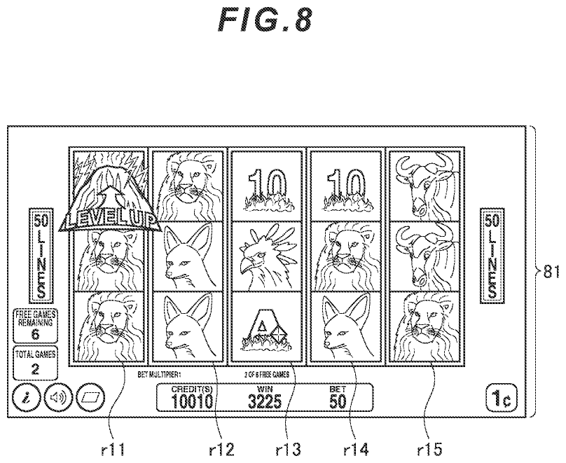

In the foregoing, the description has been given of the example in which the credits corresponding to the figure displayed on the symbol displayed in the sub-panel 102b are awarded as the bonus (privilege), but the type of the bonus is not limited thereto. A description will be given of another example with reference to FIG. 7 and FIG. 8.

A description will be given of an example in which the right to play the bonus game is awarded as the bonus with reference to FIG. 7. FIG. 7 shows an image 70 which is displayed in the display devices 102 when the spin of the reels is stopped by the control of the control section 201. In the image 70, the special symbol indicative of a volcano described above is displayed in the upper tier of the reel r14 in an image 71 displayed in the main panel 102a. In addition, in an image 72 displayed in the sub-panel 102b, a symbol indicative of crystal is displayed in the upper tier of the column 14c which is the position (second position) corresponding to the position (first position) at which the special symbol is displayed in the image 71. In the present embodiment, the symbol of crystal is associated with a right to obtain any of bonuses. Consequently, in the example shown in FIG. 7, in the case where the crystal is obtained, direction in which any of displays which are “GRAND JACKPOT”, “MAJOR JACKPOT”, “MINOR BONUS”, and “MINI BONUS” comes out of the crystal is performed, and the corresponding bonus is awarded to the player.

In addition, a bonus having a value higher than that when the special symbol (first symbol) is displayed, which is shown in FIG. 8, may be awarded to the player. FIG. 8 shows an image 81 which is displayed in the main panel 102a when the spin of the reels is stopped by the control of the control section 201. An enhancement symbol (second symbol) with the wording “LEVEL UP” on the special symbol is displayed in the upper tier (first position) of the reel r11 in the image 81. In the case where the enhancement symbol is displayed, the number of credits of the column corresponding to the reel in which the enhancement symbol is present, which is displayed in the sub-panel 102b when the next and subsequent free games are played, is increased. That is, in FIG. 8, the enhancement symbol is present in the reel r11, and hence the number of credits of the corresponding column c11 is increased, and the next and subsequent free games can be played.

[Process Flow]

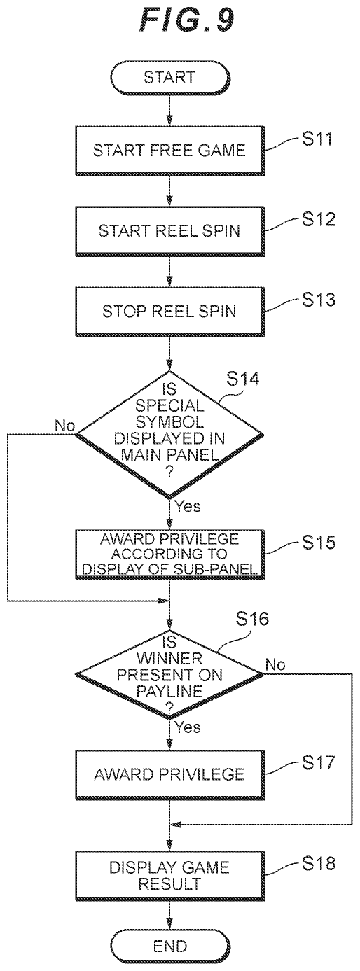

Next, a description will be given of an example of a process flow during the play of the game executed in the game device 100 with reference to FIG. 9.

The control section 201 loads a computer program stored in the storage device 204 or the like into the memory 203 and executes the computer program to control hardware of the game device 100, whereby the process is executed. Note that the individual process steps included in the process flow described below can be executed after the order of execution is arbitrarily changed, or in parallel in a range which does not cause a contradiction in the process content. In addition, another step may be additionally executed between the individual process steps in a range which does not cause a contradiction in the process content. Further, while a step described as one step for the sake of convenience can be executed after being divided into a plurality of steps, a step described as a plurality of steps for the sake of convenience can be grasped as one step. Note that the details of the process of each process step are already described, and hence the description thereof will be omitted.

The process is started when the placement or type of the symbols displayed in the display device 102 satisfies a predetermined condition when the spin of the reels is stopped in the normal game, and the state in which the free game can be played is established.

First, the control section 201 starts the free game (Step S11), and starts the spin of the reels (Step S12). Specifically, the control section 201 displays a image in which a plurality of reels having a plurality of symbols which are shown on their surfaces spin in the main panel 102a based on data read from the storage device 204. With this, the symbols are successively displayed in a plurality of areas provided in the main panel 102a, and the display of the symbols in the plurality of areas is changed.

Thereafter, the control section 201 stops the change of the display of the symbols by stopping the spin of the reels in the image displayed in the main panel 102a at predetermined timing (Step S13).

When the spin of the reels is stopped, the control section 201 determines whether or not the above-described special symbol is displayed in the main panel 102a (Step S14). The process proceeds to Step S15 in the case where the special symbol is displayed, and the process proceeds to Step S16 in the case where the special symbol is not displayed.

In Step S15, the control section 201 awards the player the privilege corresponding to the symbol displayed at the second position in the sub-panel 102b which corresponds to the first position at which the special symbol is displayed in the main panel 102a. For awarding of the privilege, the control section 201 updates data stored in the storage device 204 such that data on the awarded privilege is stored in association with data which identifies the player. An example of the process for awarding the privilege in Step S15 is as described with reference to FIG. 4.

In Step S16, when the spin of the reels is stopped, the control section 201 determines whether or not, among the placements of the symbols displayed in the main panel 102a, the placement of the symbol display matching a payline is present. For example, it is determined whether or not the symbol display stopped on the payline is a winning symbol display. The process proceeds to Step S17 in the case where it is determined that the symbol display is the winning symbol display, and the process proceeds to Step S18 in the case where it is determined that the symbol display is not the winning symbol display.

In Step S17, the control section 201 awards the privilege to the player based on the placement of the symbol display which is determined to be the winning symbol display in Step S16 and data read from the storage device 204. For awarding of the privilege, the control section 201 updates the data stored in the storage device 204 such that data on the awarded privilege is stored.

In Step S18, the control section 201 displays the direction of the game and the game result (information on the awarded privilege or the like) in the display devices 102 according to the determination results in Steps S14 and S16. An example of the method for displaying the direction of the game and the game result in the display devices 102 is as described with reference to FIG. 4, FIG. 5, and FIG. 6.

Thus, according to the present embodiment, the game device 100 causes the sub-panel 102b to display the image during the game in addition to the image displayed in the main panel 102a. When the special symbol is displayed at the first position of the main panel 102a, the privilege corresponding to the symbol displayed at the second position in the sub-panel 102b which corresponds to the first position is awarded to the player. As a result, the privilege is awarded based on the images displayed in the two panels, and hence it is possible to implement the game having higher interest.

[Modification]

The present invention is not limited to the above embodiment, and may be variously modified and implemented without departing from the gist thereof. That is, the above embodiment is only exemplary in all respects and should not be interpreted as being restrictive, and various modifications may be adopted.

For example, in the above embodiment, the description has been given of the example in which the bonus is won when the crystal is obtained, but the player may be allowed to play the bonus game.

In addition, in the above embodiment, the description has been given of the process in which, in the free game, when the special symbol is displayed at the first position in the main panel 102a, the privilege corresponding to the symbol displayed at the second position in the sub-panel 102b which corresponds to the first position is awarded to the player. However, the above process in which the privilege is awarded to the player may be performed in the normal game.

Further, the program for implementing each embodiment of the present invention described above may be stored in a recording medium. When the recording medium is used, it is possible to install the above program in a computer. Herein, the recording medium which stores the above program may be a non-transitory recording medium. The non-transitory recording medium is not particularly limited and, for example, the non-transitory recording medium may be a recording medium such as a CD-ROM.

### REFERENCE SIGNS LIST

100 Game device
101 Speaker
102 Display device
103 Operation input device
104 Card reading device
105 Bill insertion device
106 Ticket delivery device
201 Control section
202 CPU
203 Memory
204 Storage device
205 Sound processing section
206 Image processing section
207 Communication section
208 Peripheral device interface

What is claimed is:

1. A game device comprising: a control section, a storage section and a display section, wherein the control section is configured to, by executing a program stored in the storage section:
display an image of spin of a reel in a first display area of the display section, and
update, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

2. The game device according to claim 1, wherein the privilege is a right to play a bonus game.

3. The game device according to claim 1, wherein the control section is configured to further update, when the privilege is awarded, a display of the second display area such that a display of the symbol displayed at the second position is erased, and the position where the display of the symbol is erased is occupied by another symbol.

4. The game device according to claim 1, wherein the control section is configured to further update, in a case where a second symbol is displayed in the first display area when the spin of the reel is stopped, the data stored in the storage section such that a content of a privilege for a symbol displayed in the second display area according to a position at which the second symbol is displayed in the first display area is upgraded.

5. The game device according to claim 1, wherein the control section is configured to further display, when the privilege is awarded, an image corresponding to the privilege at the first position.

6. A game control method which is performed in a game device including a control section, a storage section, and a display section, the game control method comprising:
the control section displaying an image of spin of a reel in a first display area of the display section; and
the control section updating, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.

7. A recording medium which stores a program for causing a game device including a control section, a storage section, and a display section to execute a game control method, the game control method including:
the control section displaying an image of spin of a reel in a first display area of the display section; and
the control section updating, in a case where a first symbol is displayed in the first display area when the spin of the reel is stopped, data stored in the storage section such that a privilege corresponding to a symbol displayed at a second position in a second display area of the display section which corresponds to a first position at which the first symbol is displayed in the first display area is awarded to a player.
